(19) United States
(12) Patent Application Publication
(10) Pub. No.: US 2017/0255959 A1
(43) Pub. Date: Sep. 7, 2017

(54) SYSTEM AND METHOD FOR ACCURATE MARKETING BASED ON SHARING OF DATA, GIFTS AND LOGISTICS

(71) Applicants: Xiancai Pan, Richmond (CA); Feng Ye, Richmond (CA)

(72) Inventors: Xiancai Pan, Richmond (CA); Feng Ye, Richmond (CA)

(21) Appl. No.: 15/510,687

(22) PCT Filed: Jul. 11, 2016
(86) PCT No.: PCT/IB2016/001403

§ 371 Date: Mar. 11, 2017

Related U.S. Application Data
(60) Provisional application No. 62/191,333, filed on Jul. 11, 2015.

(51) Int. Cl. G06Q 30/02

(52) U.S. Cl. CPC G06Q 30/0236; G06Q 30/0276; G06Q 30/0253; G06Q 30/0222; G06Q 30/0203

(57) ABSTRACT

An Internet based system and method for accurate marketing based on sharing of data, free advertising gifts and logistics includes a cross-web software application that runs in a network of computers. The application supports a marketing platform website with an interface for marketers to define and initiate a marketing project of delivering one or more types of free advertising gift to a targeted group of consumers. The application is communicatively coupled to a number of business-to-consumer websites that enable consumers to complete purchase transactions online. A consumer who is browsing or purchasing in one of the business-to-consumer websites is prompted whether or not he/she desires to accept a free gift. The consumer, if he/she responds positively, is directed to a page for registration and gift selection. The consumer will receive his/her selected gift through a delivery channel designated by the marketing website. By the multi-layer sharing mechanism, this system integrates data sharing, advertising sharing, and logistics sharing to reduce advertising cost, reduce gifts production and distribution costs, improve precision in consumer targeting, and improve brand recognition, and thus leads to lower impact on the environment.

### CROSS REFERENCE TO RELATED APPLICATIONS

This application is based on, and claims the benefit of priority to, U.S. Provisional Patent Application Ser. No. 62/191,333, entitled “method for providing advertising gifts through business-to-consumer websites” filed on Jul. 11, 2015, the content of which being incorporated in its entirety by reference herein.

### FIELD OF THE INVENTION

The present invention generally related to Internet based network for e-commerce marketing, and more particularly it relates to a system and method for accurate marketing based on big data sharing and logistics sharing with business-to-consumer websites and distributing advertising gifts or product samples to a targeted group of consumers and thus creating a multi-layer object-to-object shared economy marketing model, increasing the conversion rate from leads to actual customers.

### BACKGROUND OF THE INVENTION

The traditional media such as magazine, newspapers and outdoor signs, has less and less percentage in the advertising market. The input in the traditional marketing media is high but the output is low. The Internet marketing increases fast in the last decade. However, the conversion rate is not quite promising. For example, the conversion rate of Google's accurate marketing is about 5%.

Electronic commerce (e-commerce) is an increasingly popular way of conducting business, typically, but not exclusively, including activities such as browsing for items; comparing product aspects such as price, color, warranties, and the like for multiple items; inspecting product details of an item; purchasing one or more items; and the like. More and more vendors are making their products and services available over electronic networks, such as the Internet, and computer users have embraced electronic commerce as a legitimate shopping environment.

Both vendors and computer users greatly benefit from e-commerce in a variety of ways. For example, users do not have to travel to a number of vendor locales to purchase a given item. Rather, a user can now purchase a desired item from the convenience of his or her home. Furthermore, users can quickly compare a wide variety of similar products and prices from a number of vendors in order to make an informed choice in their purchases rather than spending an entire afternoon in comparison shopping. Vendors are benefited in that they can reach a much larger group of customers than those who reside in their geographic vicinity.

Business-to-customer (B2C) marketing refers to the tactics and best practices used to promote products and services among consumers. Like most forms of marketing, technology has greatly expanded the number of channels that B2C marketers must use in their campaigns. In the era of e-commerce, the Internet has provided a critical medium for the delivery of relevant content and information designed to educate prospects and generate demand, rather than simply promote brands. Branded content is increasingly part of consumers' shopping process, and it is reported that more than one quarter of all consumers going to business websites for information prior to making a purchase.

Currently, global B2C e-commerce is very mature and has a huge body of customers, which provides a solid foundation to the present invention, namely providing advertising gifts through B2C websites. According to eMarketer (www.eMarketer.com), total sales of B2C e-commerce was 1200 billion dollars in 2013, which increased 17% comparing with 2012. Furthermore, there would be 1.03 billon people conducted business through B2C e-commerce, and currently in the United States, there are 156 million people shopping online. The table below illustrates the B2C e-commerce sales worldwide.

So far, the B2C websites make profits by sales of merchandises and advertisement. The distribution channels are all for the merchandises ordered by the customers. No B2C companies use the distribution channel to make other profits like sending the advertising gifts, which may be a waste.

The Advertising Specialty Institute released its annual sales analysis for the US promotional products industry, showing total sales during 2013 of $20.5 billion, up 5.3% from 2012, with continued strong sales forecast throughout 2014. One of the conventional methods for providing advertising gifts is to randomly providing advertising gifts to people walking on the street or randomly sending such gifts through regular mail.

This conventional strategy is disadvantageous because it is less selective and does not specifically focus on targeted consumers. When a person receives a marketing gift that does not interest him/her, he/she usually discards it right away, which causes waste to the gift provider and it is not considered an efficient marketing technique.

According to Wordstream, the average conversion rate on Google search in Q3 2012 was 5.63 percent, and that on Google display network was 4.68 percent. How to lower advertising costs for clients? How to achieve precision in targeting end consumers? Ultimately, how to increase conversion rates? How to improve marketing effectiveness?

Research shows that free samples can lead to a conversion rate as high as 33%. Free gifts that consumers can observe and keep for a long time lead to stronger brand recognition. However, the main challenges for effective free samples are to identify the right customers, and to produce and deliver samples in a cost effective and timely manner. With customer profile and transaction information, big data can help target the right customers, thus increasing the conversion rate as well as reducing uncertainty in sample production. Big Data Executive Survey 2013 reported that 77% of the respondents reported sales and marketing as business functions that drive investments in big data.

Meanwhile, sharing fulfillment services among companies can directly reduce costs in storing, packaging, and delivering samples. But free gifts/samples can be expensive to produce and deliver and may be targeted at the wrong customers. Shared advertising through free gifts/samples can lower advertising costs for an individual company.

What is desired is a system and method for accurate marketing based on big data sharing and logistics sharing with business-to-consumer websites and distributing gifts or product samples to a targeted group of consumers that is selected using big-data analysis and artificial intelligence means.

### SUMMARY OF THE INVENTION

It is an object of the present invention to provide a system and method for sending advertising gifts or product samples through B2C websites to more precisely target on consumers who may be interested in the gifts.

It is another object of the present invention to utilize existing B2C distribution channel to make profits by distributing advertising gifts.

It is still another object of the present invention to provide a method for sending advertising gifts through B2C websites to save the marketing costs, including advertisement costs, labor costs, delivery costs, etc.

It is a further object of the present invention to provide different free advertising gifts to the consumers constantly, which may increase the consumer's motivation to continuously shop at this B2C website to further increase the sales number of the B2C website.

It is still a further object of the present invention to provide a method for sending advertising gifts or product samples through B2C websites to promote online shopping and further increase sales numbers associated with the advertising gifts.

It is still a further object that the B2C websites determine the types and numbers of the advertising gifts and invites gifts manufacturers to manufacture the advertising gifts, so as to increase the participation of the business especially the mid-size companies.

Yet it is another object that a system integrates data sharing, advertising gifts sharing, and logistics sharing to reduce advertising cost, reduce gifts production and distribution costs, improve precision in consumer targeting, and improve brand recognition, and thus leads to lower impact on the environment.

The present invention provides an Internet based system and method for accurate marketing based on sharing of customers' data, advertising gifts and B2C websites' logistics.

The system includes a cross-web software application that runs in a network of computers. The application supports a marketing platform website with an interface for marketers to define and initiate a marketing project of delivering one or more types of free gift to a targeted group of consumers. The interface also enables the regular consumers to register for receiving free gifts. The application is communicatively coupled to a number of B2C websites that enable their consumers to complete purchase transactions online.

A consumer who is browsing or purchasing in one of the B2C websites is prompted whether or not he/she desires to accept a free gift. The consumer, if he/she responds positively, is directed to a page or a pop up window for registration and gift selection. The consumer will receive his/her selected gift through a delivery channel designated by the marketing website. He/she will also receive other gifts from the marketing websites because his/her information is stored in a database wherefrom a group of targeted consumers will be selected by one or more marketers through the marketing website.

The present invention has multi-layer sharing effect. In one aspect, usually a small business may have a few hundreds of gifts to be distributed. B2C website is not willing to accept the job because it requires hundreds of logistics arrangements. However, the system according to this invention enables various businesses bundle together to order the advertising gifts, deliver the gifts to the B2C distribution center, and distribute the free advertising gifts by sharing the logistics. In another aspect, usually each business orders its own advertising gift. However, the system according to this invention enables at least two businesses to share one gift or more gifts. For example, one or more logos could be printed on a gift such as a box of tissue. Yet in another aspect, small business is usually not eligible to share big data with big B2C business. However, the system according to this invention enables various business to share big data and thus it increases the precision of the customers targeting.

### BRIEF DESCRIPTION OF THE DRAWINGS

FIG. 1 is flow diagram illustrating the steps of providing advertising gifts through B2C websites according to the present invention.

FIG. 2 is a flow diagram illustrating one embodiment of the present invention.

FIG. 3 is a flow diagram illustrating another embodiment of the present invention.

### DETAILED DESCRIPTION OF THE INVENTION

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principles of the invention as described herein are contemplated as would normally occur to one skilled in the art to which the invention relates.

The present invention provides an Internet based system and method for accurate marketing based on sharing of customers' data between a marketing platform website with a number of B2C websites, sharing advertising gifts by two or more marketers, and sharing the B2C websites' logistics. The system includes a cross-web software application that runs in a network of computers. The software application supports the marketing platform website with an interface for various marketers to define and initiate a marketing project of delivering one or more types of free gift to a targeted group of consumers that is selected using big-data analysis and artificial intelligence. The software application includes a number of modules to fulfil various functions. It is communicatively coupled to a number of B2C websites that enable their consumers to complete purchase transactions online.

In a typical operation in the system, a consumer who is browsing or purchasing in one of the B2C websites is prompted whether or not he/she desires to accept a free gift. The prompting means can be a pop-up window, a pop-up bubble, or a pop-up link with a short audio notice. The consumer, if he/she responds positively, is directed to a page for registration and gift selection. The prompting process can be implemented in different ways, for example, before the consumer placing an order, before the consumer checking out, or any time when the consumer browsing in the B2C website. After the selection, the consumer will receive his/her selected gift through a delivery channel designated by the marketing website. The delivery channel can be the B2C website's logistics, the seller's logistics, or even a third party's logistics designated by the marketing platform website. Because after the registration, the consumer's characteristics information is stored in a database associated with the marketing platform website, he/she can be selected in one or more categories of consumers in the future and can receive free advertising gifts from the marketing platform websites.

The software application includes a module that enables the B2C websites to share certain customers' data with the marketing platform website according to a protocol made between each B2C website and the marketing platform website. The protocol specifies the scope and limits of information sharing. The module enables the marketing platform website to select a group of consumers by analyzing data from one or more databases storing consumers' data and screening according to one or more parameters such as sex, age, hobby, income level, education, geographic information, etc. When a marketer needs to make and launch a marketing project, he can login and define the gifts and the group of target customers according to his own criteria such as such as sex, age, hobby, income level, education, city, etc.

The software application also includes a module that enables each of the B2C websites to share logistics information and services with the marketing platform website for optimizing gift delivery channel according to a protocol made between each B2C website and the marketing platform website. The protocol specifies the scope and limits of logistics sharing and cooperation. The module enables the marketing platform website to select an optimized channel by analyzing data from one or more databases storing logistics data and screening according to one or more parameters such as time and cost, etc. In a typical implementation, the goods purchased by the customer and the free gift selected by the customer are packed together and delivered together to the customer. In other words, when the consumer opens the package he/she received, he would see the goods he purchased and the free gift he selected. In some other situation, for example, a registered customer may receive an unexpected gift because his/her name is in the database and he/she can be selected as a member of the group of target consumers. In other words, when the consumer opens the package he/she received, he would see the goods he purchased and an unexpected gift free of charge.

The software application also includes a module that enables any one to register from the marketing platform website and make gift selection from a variety of choices and consent to receive unexpected gifts from the marketing platform website. The information of the registered visitors is stored in the databases associated with the marketing platform website. He/she could be selected as a member of a targeted group of consumers from time to time and receive unexpected free gifts from time to time.

The software application also includes a module that enables a marketer or a seller to register from the marketing platform website, determine a specific type and amount of gift, and specify a category of consumers who will receive the determined gift. The marketing platform website offers a variety of choices gift designs. The marketers or sellers can even upload their own designs of advertisements and/or gift designs. If the marketer needs customized gifts, the marketing platform website offers various services to meet the needs.

The free gift distributed through the system is typically a physical item, such as a box of tissue, having one or more surficial areas that can be designated for advertising. The marketing platform website may also have an interface for bidding by all marketers or sellers. The software application enables the marketers or sellers to bit on the segmented surficial areas for their advertising following the bidding rules and policies set forth by the marketing platform website. For example, a tissue box has at least five sides (top, back and front, right and left) for advertisement placement. The five sides can be used by one marketer or shared by two or more marketers.

The present invention is also implemented as a computer network based method for accurate marketing based on sharing of data, gifts and logistics. The method includes steps of:
providing a cross-web software application that runs in the network and supports a marketing platform website where the marketers can conveniently launch a marketing project;
providing an interface for a marketer to define and initiate its marketing project of delivering one or more types of free gift to a targeted group of consumers;
communicatively linking the marketing platform website to a number of B2C websites that enable consumers to complete purchase transactions online;
prompting a consumer who is browsing or purchasing in one of the B2C websites whether or not he/she desires to accept a free gift;
returning a page or a pop-up window to the consumer for registration and gift selection, if he/she responds positively; and
delivering the selected gift to the consumer through a delivery channel designated by the marketing platform website.

In a typical implementation, when the marketing platform website receives the gift claiming information from a B2C website, it will provide a predetermined amount of gifts to the B2C website. Upon receiving certain conditions, the B2C website selects the consumers who may be interested in the gifts provided by the marketer. When one of the consumers shops on the B2C website, the B2C website provides one or more gifts provided by the marketer to the consumer i.e. the gift receiver. The B2C website then sends the gift(s) selected by the gift receiver along with the items purchased by the gift receiver.

In one implementation, the predetermined conditions may include, but not limited to, gift size/weight, targeted areas to send the gifts, targeted age of people to receive the gifts, gift receivers' hobbies/income, sex, title, gift receivers' shopping histories, etc., which can be referred to the “big data” from the B2C website. In other words, the present invention is taking advantage of the B2C websites' big data to more precisely target potential gift receivers to efficiently deliver the advertising gifts and prevent waste of marketing resources. In another embodiment, the B2C websites may include, but not limited to Amazon, eBay, COSTCO, Groupon, Walmart, etc. Big data is an evolving term that describes any voluminous amount of structured, semi-structured and unstructured data that has the potential to be mined for information. Although big data does not refer to any specific quantity, the term is often used when speaking about petabytes and Exabyte of data. Big data is changing the way people within organizations work together, and creating a culture in which business and IT leaders must join forces to realize value from all data.

To increase more business participation with the marketing strategy in the present invention, the B2C websites may invite other business entities to manufacture at least a portion of the advertising gifts, so the B2C websites can customize the advertising gifts according to the predetermined conditions including gift size/weight, targeted areas to send the gifts, targeted age of people to receive the gifts, gift receivers' hobbies/income, sex, title, gift receivers' shopping histories, etc., as mentioned above, and the gift manufacturers can get involved in making at least a portion of the gifts if they see a need. More specifically, instead of receiving the advertising gifts from the marketer, the B2C websites can invite one or more gift manufacturers to make the gifts according to the “big data” possessed by the B2C websites, which may include steps of: B2C websites customizing the advertising gifts according to the predetermined conditions; inviting one or more gift manufacturers to manufacture the advertising gifts; and each gift manufacturers selecting at least a portion of the marketing gift to manufacture.

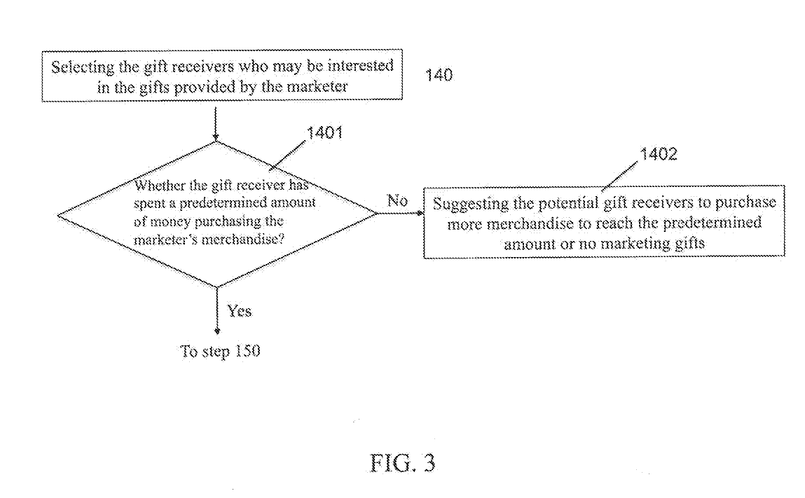

In order to further understand the goal, characteristics and effect of the present invention, examples of implementations are described. In one aspect, as shown in FIG. 1, a computer implemented method of providing advertising gifts through B2C websites may include steps of: marketer selecting a B2C website 110; marketer providing predetermined conditions to the B2C website to select a group of gift receivers who may be interested in the gifts provided by the marketer 120; marketer providing a predetermined amount of gifts to the B2C website 130; upon receiving the predetermined conditions in step 120, the B2C website analyzing the predetermined conditions and existing customer data in the B2C website database and selecting the gift receivers who may be interested in the gifts provided by the marketer 140; when one of the gift receivers shopping on the B2C website, the B2C website providing one or more gifts provided by the marketer to the gift receiver 150; the B2C website sending the gift(s) selected by the gift receiver along with the purchased items to the person 160.

In a typical implementation, the predetermined conditions in step 120 may include, but not limited to, gift size/weight, targeted areas to send the gifts, targeted age of people to send the gifts, gift receivers' hobbies, income level, sex, title, gift receivers' shopping histories, etc., which can be referred to the “big data” from the B2C website. In other words, the present invention is taking advantage of the B2C websites' big data to more precisely target potential gift receivers to efficiently deliver the advertising gifts and prevent waste of marketing resources. In another embodiment, the B2C websites may include, but not limited to Amazon, eBay, COSTCO, Groupon, Walmart, etc.

To increase more business participation with the marketing strategy in the present invention, the marketer may invite other business entities to manufacture at least a portion of the advertising gifts, so the B2C marketer can customize the advertising gifts according to the predetermined conditions including gift size/weight, targeted areas to send the gifts, targeted age of people to receive the gifts, gift receivers' hobbies/income, sex, title, gift receivers' shopping histories, etc., as mentioned above, and the gift manufacturers can get involved in making at least a portion of the gifts if they see a need.

More specifically, instead of receiving the advertising gifts from the marketer, the B2C websites can invite one or more gift manufacturers to make the gifts according to the “big data” possessed by the B2C websites (step 130′), which may include steps of: B2C websites customizing the advertising gifts according to the predetermined conditions 1301′; inviting one or more gift manufacturers to manufacture the advertising gifts 1302′; and each gift manufacturers selecting at least a portion of the marketing gift to manufacture 1303′, as shown in FIG. 2. The B2C website can also provide a platform for the gift manufacturers to sign up for manufacturing a specific portion of the gift.

In another implementation, the gift receivers may have to spend a predetermined amount of money purchasing the marketer's merchandise. As shown in FIG. 3, the step of selecting the gift receivers who may be interested in the gifts provided by the marketer 140 may include steps of determining if the gift receiver has spent a predetermined amount of money purchasing the marketer's merchandise 1401; and if the gift receiver has not spent a predetermined amount of money, step 1402 may suggest the potential gift receivers to purchase more merchandise to reach the predetermined amount or no advertising gifts.

Comparing with conventional B2C marketing strategies, the method provided in the present invention is advantageous because the B2C websites have existing customer database that can be further filtered to select a group of people that may be interested to a specific kind of gift(s). When the selected group people receive the gift, they may use or keep the gifts instead of discarding the gifts. Furthermore, they may further purchase the products related to the gifts which may be beneficial to both the B2C websites and the gift provider.

Also, sending the gifts to a selected group of people who may be interested can prevent waste of the resources. If the gifts are randomly distributed like conventional B2C marketing strategy, people who are not interested in the gifts may just throw them away, which is not only a waste of resources, but also increase the costs of the marketer. And if one gift becomes popular among people, the gift can become a merchandise for sale, which is also beneficial to the B2C website that provides the gift and may invite more people to visit the B2C website to increase other potential sales.

Moreover, the present invention is advantageous because it is taking advantage of the B2C websites' big data to more precisely target potential gift receivers to efficiently deliver the advertising gifts and prevent waste of marketing resources. It also creates opportunities for the gift manufacturers to participate in manufacturing the advertising gifts, so the B2C websites can lower their own operation costs and risks.

While one or more embodiments of the present invention have been illustrated above, the skilled artisan will appreciate that modifications and adoptions to those embodiments may be made without departing from the scope and spirit of the present invention.

1. An Internet based system for accurate marketing based on sharing of data, gifts and logistics, comprising a cross-web software application that runs in a network of computers, wherein said application supports a marketing website with an interface for a marketer to define and initiate a marketing project of delivering one or more types of free gift to a targeted group of consumers defined by said marketer; wherein said application is communicatively coupled to a number of business-to-consumer websites that enable consumers to browse and complete purchase transactions online; wherein a consumer who is browsing in one of said business-to-consumer websites is prompted whether or not he/she desires to accept a free gift; wherein said consumer, if he/she responds positively, is directed to a page for registration and gift selection; and wherein said consumer will receive his/her gift through a delivery channel designated by said marketing website.

2. The system of claim 1, wherein said software application includes a first module that enables each of said business-to-consumer websites to share certain customers' data with said marketing website according to a first protocol there between.

3. The system of claim 2, wherein said first module enables said marketing website to define a group of consumers by analyzing data from one or more databases storing consumers' data and screening according to a number of parameters preset by said marketer.

4. The system of claim 1, wherein said software application includes a second module that enables each of said business-to-consumer websites to share logistics information and service with said marketing website for optimizing gift delivery channel according to a second protocol there between.

5. The system of claim 4, wherein goods purchased by said customer and said free gift selected by said customer or designated by said marketing website are packed together for delivery.

6. The system of claim 1, wherein said software application includes a third module that enables a consumer to register from said marketing website by entering a number of pieces of information for receiving gifts available from said marketing website.

7. The system of claim 1, wherein said application includes a fourth module that enables a marketer to register from said marketing website, determine a specific type and amount of gift, and specify a category of consumers who will receive said determined gift.

8. The system of claim 7, wherein said free gift is a physical item having one or more surficial areas that can be designated for advertising, and wherein said fourth module enables various marketers to bit on said surficial areas for its advertising.

9. In an Internet based network of computers, a method for accurate marketing based on sharing of data, gifts and logistics, comprising steps of:
providing a cross-web software application that runs in said network and supports a marketing website;
providing an interface for a marketer to define and initiate a marketing project of delivering one or more types of free gift to a targeted group of consumers;
communicatively linking said marketing website to a number of business-to-consumer websites that enable consumers to complete purchase transactions online;
prompting a consumer who is purchasing from one of said business-to-consumer websites whether or not he/she desires to accept a free gift;
returning a page to said consumer for registration and gift selection if he/she responds positively; and
delivering said selected gift to said consumer through a delivery channel designated by said marketing website.

10. The method of claim 9, further comprising the step of:
providing a first module that enables each of said business-to-consumer websites to share certain customers' data with said marketing website according to a first protocol there between.

11. The method of claim 10, wherein said first module enables said marketing website to select a group of consumers by analyzing data from one or more databases storing consumers' data and screening according to one or more parameters.

12. The method of claim 9, further comprising the step of:
providing a second module that enables each of said business-to-consumer websites to share logistics information and service with said marketing website for optimizing gift delivery channel according to a second protocol there between.

13. The method of claim 12, wherein goods purchased by said customer and said free gift selected by said customer are packed together for delivery.

14. The method of claim 9, further comprising the step of:
providing a third module that enables a consumer to register from said marketing website by entering a number of pieces of information for making gift selection from a variety of choices and receiving other gifts available from said marketing website.

15. The method of claim 9, further comprising the step of:
providing a fourth module that enables a marketer to register from said marketing website, determine a specific type and amount of gift, and specify a category of consumers who will receive said determined gift.

16. The system of claim 15, wherein said free gift is a physical item having one or more surficial areas that can be designated for advertising, and wherein said fourth module enables various marketers to bit on said surficial areas for its advertising.
